(19) United States
(12) Patent Application Publication
(10) Pub. No.: US 2026/0177002 A1
(43) Pub. Date: Jun. 25, 2026

(54) ELECTRIC GENERATOR IN TURBINE ENGINE

(71) Applicants: Rolls-Royce North American Technologies, Inc., Indianapolis, IN (US); Rolls-Royce Corporation, Indianapolis, IN (US)

(72) Inventors: Robert W. Heeter, Indianapolis, IN (US); Daniel E. Molnar, Jr., Indianapolis, IN (US); Jordan Thralls, Indianapolis, IN (US)

(21) Appl. No.: 18/988,165

(22) Filed: Dec. 19, 2024

(51) Int. Cl. F02C 6/08; F02C 6/20; F02C 7/18

(52) U.S. Cl. CPC F02C 6/08; F02C 6/20; F02C 7/18

(57) ABSTRACT

A turbine engine includes at least one compressor, combustion equipment, and at least one turbine. A stage is positioned aft of the at least one turbine, the stage comprising a plurality of blades. The turbine engine includes an electrical generator. The electrical generator includes a rotor carried on an outer diameter of the plurality of blades of the stage and mechanically rotated by the plurality of blades of the stage, the rotor configured to rotate about a longitudinal axis of the turbine engine, and a stator.

### TECHNICAL FIELD

This disclosure relates to electrical power generation in turbine engines.

### BACKGROUND

A turbine engine is a type of internal combustion engine that may drive an electric generator for converting mechanical power produced by the turbine engine to electrical power used by other components of a system. Some applications (e.g., due to size and weight restrictions) may require the electric generator to be located within the housing of the turbine engine. During operation, some internally-located electric generators may produce excess heat that may interfere with operations being performed by the electric generator and/or other collocated components of the turbine engine. In addition, performing maintenance or inspections of some internally-located electric generators (such as on central shafting within the core) may be difficult as other collocated components of the turbine engine obstruct access to the electric generator.

### SUMMARY

Recently, demand for electrical power on vehicles (e.g., aircraft and others) has increased. For example, larger electronics and/or hybrid consideration has encouraged incorporation of new or additional electrical generator capability on turbine engines, including turbofans. Electrical generators may be positioned at various locations on turbine engines. As one example, an electrical generator may be positioned on an outside of the turbine engine and be driven by a drive shaft off a compressor. However, positioning the generator on the outside of the turbine engine may be limiting due to size constraints (e.g., on generator physical size) and/or may add mechanical complexity and weight to the turbine engine.

Positioning an electrical generator such that the electrical generator shares a principal axis with the turbine engine may be advantageous to reduce mechanical complexity of the engine. However, components of the electrical generator may have temperature limits that are exceeded by the temperatures in some portions of the turbine engine. One example location that may be relatively cool enough to house an electrical generator is in a fore portion of the engine core (e.g., a fan section). However, locating a generator in a fan section of turbine engine may involve tying rotation of the electrical generator to one or more components (e.g., a low-pressure shaft which rotates a low-pressure compressor and a low-pressure turbine). Such an arrangement may result in increased mechanical complexity and/or reduced turbine engine and/or electrical generator performance.

In accordance with one or more examples of the present disclosure, a turbine engine includes at least one compressor, combustion equipment, and at least one turbine. The turbine engine also includes an electrical generator. The electrical generator shares a principal longitudinal axis with the turbine engine and is positioned aft of the at least one turbine. Space in such a location may be available for inclusion of an electrical generator capable of generating a relatively large amount of power relative to the power output of electrical generators located in external (e.g., off-axis) or upstream positions.

Other benefits of an on-axis electrical generator positioned aft of at least one turbine may be realized. For example, a core airflow flowing through the turbine engine may be expanded less than possible by the at least one turbine. The electrical generator may use some or all of the available expansion ratio to generate rotation of a rotor of the electrical generator relative to a stator of the electrical generator. Since rotation of the rotor may be driven by the flow of air through the engine, the electrical generator may be mechanically decoupled from other components of the turbine engine and operated as a free stage which mechanically drives the rotor of the electrical generator.

However, an electrical generator positioned aft of at least one turbine may be located downstream of combustion equipment configured to combust the core airflow. Temperatures in such a location may exceed a threshold temperature, above which components of the electrical generator may deteriorate, and performance of the electrical generator may suffer. In some aspects of the present disclosure, an electrical generator may include a rotor and a stator. The stator and/or the rotor may be cooled by bypass airflow, which may be air flowing through the turbine engine radially outside of a casing which bifurcates an inlet airflow into the core airflow and the bypass airflow. Thus, at least a portion of the electrical generator may be exposed to relatively cool air, which may enable the electrical generator to survive being positioned on-axis in the hot section of the turbine engine. Furthermore, thermal management with cooling air from the bypass airflow may advantageously manage heat generated by the electrical generator without necessarily adding a heavy, complex thermal management system, which often include one or more of a flooded stator, a heat exchanger, coolant lines, and the like. Instead, turbine engines of the present disclosure do not need to include additional thermal management equipment.

An example turbine engine includes at least one compressor, combustion equipment, and at least one turbine. A stage is positioned aft of the at least one turbine, the stage comprising a plurality of blades. The turbine engine includes an electrical generator. The electrical generator includes a rotor carried on an outer diameter of the plurality of blades of the stage and mechanically rotated by the plurality of blades of the stage, the rotor configured to rotate about a longitudinal axis of the turbine engine, and a stator.

An example airframe includes a first turbine engine of one or more turbine engines. The first turbine engine includes at least one compressor, combustion equipment, and at least one turbine. A stage is positioned aft of the at least one turbine, the stage comprising a plurality of blades. The turbine engine includes an electrical generator. The electrical generator includes a rotor carried on an outer diameter of the plurality of blades of the stage and mechanically rotated by the plurality of blades of the stage, the rotor configured to rotate about a longitudinal axis of the turbine engine, and a stator.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating a cross-section of a turbine engine with an electric generator for producing electrical power, in accordance with one or more aspects of this disclosure.

FIG. 2 is a conceptual diagram illustrating further details of an example turbine engine with an electrical generator positioned aft of at least one turbine of the turbine engine, in accordance with one or more examples of the present disclosure.

FIG. 3 is a conceptual diagram illustrating further details of an example turbine engine with an electrical generator positioned aft of at least one turbine of the turbine engine, in accordance with one or more examples of the present disclosure.

FIG. 4 is a conceptual diagram illustrating further details of an example turbine engine with an electrical generator positioned aft of at least one turbine of the turbine engine, in accordance with one or more examples of the present disclosure.

FIG. 5 is a conceptual diagram illustrating further details of an example turbine engine with an electrical generator positioned aft of variable inlet guide vane, in accordance with one or more examples of the present disclosure.

FIG. 6 is a conceptual diagram illustrating further details of one example of a turbine engine, with an electrical generator having a bypass airflow cooled stator, in accordance with one or more aspects of this disclosure.

FIG. 7 is a conceptual diagram illustrating another example of a turbine engine with an electrical generator having a bypass airflow cooled stator, in accordance with one or more aspects of this disclosure.

FIG. 8 is a conceptual diagram illustrating another example of a turbine engine with an electrical generator having a bypass airflow cooled stator, in accordance with one or more aspects of this disclosure.

FIG. 9 is a conceptual diagram illustrating a portion of an example generator which includes a hoop-rim rotor, in accordance with one or more aspects of the present disclosure.

FIG. 10 is a conceptual diagram illustrating a portion of an example generator which includes a hoop-rim rotor, in accordance with one or more aspects of the present disclosure.

FIG. 11 is a conceptual diagram illustrating a portion of an example generator which includes a hoop-rim rotor, in accordance with one or more aspects of the present disclosure.

FIG. 12 is a conceptual diagram illustrating a portion of an example generator which includes a hoop-rim rotor which includes one or more retention features, in accordance with one or more aspects of the present disclosure.

FIG. 13 is a conceptual diagram illustrating an example aircraft, in accordance with one or more aspects of the disclosure.

### DETAILED DESCRIPTION

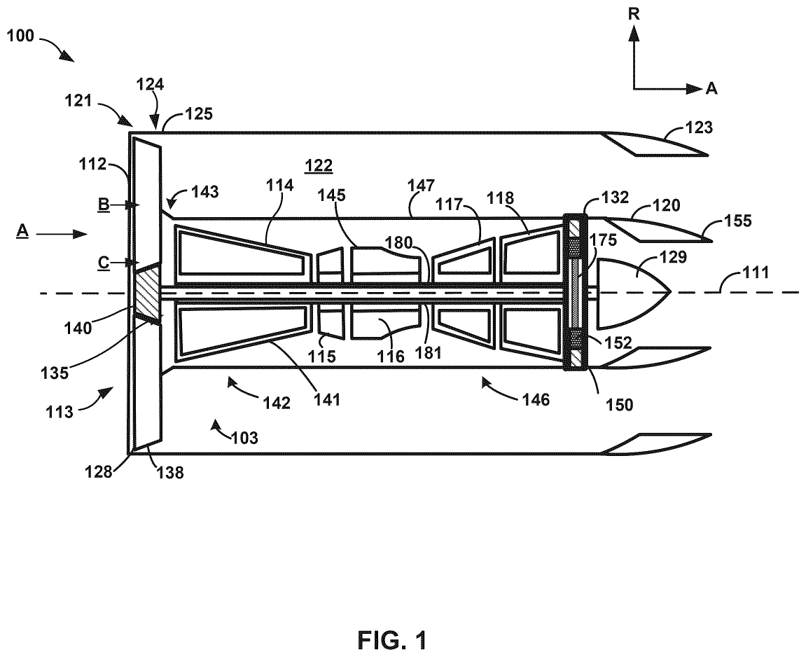

FIG. 1 is a conceptual diagram illustrating a cross-section of turbine engine 100 with an electric generator 132 for producing electrical power, in accordance with one or more aspects of this disclosure. Turbine engine 100 may be configured to convert one form of power to mechanical energy in the form of a rotating turbine. The mechanical energy produced by turbine engine 100 may be used in a variety of ways or for a variety of systems and applications (e.g., aircraft, locomotives, watercraft, power plants, electric generators, and any or all other systems and applications that rely on mechanical energy from a turbine engine to perform work). As illustrated in FIG. 1, turbine engine 100 may be a ducted fan gas-turbine engine, which may be used to propel an aircraft.

As shown in FIG. 1, turbine engine 100 has a principal and rotational longitudinal axis 111. Turbine engine 100 may include, in axial flow series, air intake 112, propulsive fan 113, high-pressure compressor 114, diffuser 115 combustion equipment 116, high-pressure turbine 117, low-pressure turbine 118 and core exhaust nozzle 155. Turbine engine 100 may include nacelle 121, which may generally surround turbine engine 100 and defines intake 112, bypass duct 122 and an exhaust nozzle 123. Turbine engine 100 may include center-plug 129 is positioned within the core exhaust nozzle 155 to provide a form for the core gas flow C to expand against and to smooth its flow from the core engine.

Turbine engine 100 may operate such that inlet air A entering the intake 112 is accelerated by fan 113 to produce two air flows: a first airflow C (i.e., “core airflow”) into high-pressure compressor 114 and a second airflow B (i.e., “bypass airflow”) which passes through bypass duct 122 to provide propulsive thrust. Fan 113 may be considered as a low-pressure compressor in such an example. Casing 141 may surround core airflow C and guide core airflow C through turbine engine 100. Casing 141 may include one or more components. For example, casing 141 may include splitter casing 143 which bifurcates inlet airflow A and bypass airflow B, core casing 145 which surrounds the core section, and/or tail casing 120 from which core airflow A is outlet. Casing 141 may include fewer or more components in other examples.

Turbine engine 100 may be a high-bypass engine (e.g., a ratio of B to C is greater than a threshold ratio) or a low-bypass engine (e.g., a ratio of B to C is less than the threshold ratio). High-pressure compressor 114 may compress the airflow C directed into it before delivering that air to diffuser 115 where the airflow may be prepared for combustion in combustor 116.

Combustor 116 may mix the entering compressed air with fuel and combust the mixture. The resultant hot combustion products may then expand through, and thereby drive the high and low-pressure turbines 117, 118 before being exhausted through nozzle 155 (and may thereby provide additional propulsive thrust). The high and low-pressure turbines 117, 118 may respectively drive the high-pressure compressor 114 and fan 113 by suitable interconnecting shafts. For instance, turbine engine 100 may include low-pressure shaft 180 that rotationally connects low-pressure turbine 118 to fan 113 and high-pressure shaft 181 that rotationally connects high-pressure turbine 117 to high-pressure compressor 114.

While illustrated and described as a two-shaft design, turbine engine 100 is not so limited. For instance, in some examples, turbine engine 100 may be a single shaft design (e.g., without separate HP/LP spools), or may be a three-shaft design which includes an intermediate-pressure compressor driven by an intermediate turbine. Similarly, aspects of this disclosure are applicable to turbine engines of all ranges of thrust and sizes.

As noted above, fan 113 may be rotated using energy collected via low-pressure turbine 118 (e.g., a power-turbine). As shown in FIG. 1, fan 113 may include a plurality of fan blades 138 connected to hub 140. Fan 113 may be circumferentially surrounded by a structural member in the form of a fan casing 124 (e.g., where turbine engine 100 is a ducted turbo-fan engine), which may be connected to an annular array of outlet guide vanes (not shown). Fan casing 124 may comprise a rigid containment casing 125 and attached rearwardly thereto may be a rear fan casing. As shown in FIG. 1, fan 113 (and/or other components of the engine core such as high-pressure compressor 114 may be connected to a core vane assembly 135.

Core vane assembly 135 may include core vanes, which may provide several functions. For instance, in addition to or in place of supporting fan 113, the core vanes may be shaped and arranged to straighten core airflow C before it reaches high-pressure compressor. While illustrated in FIG. 1 as being a directly driven fan, in other examples fan 113 may be a geared turbofan. For instance, turbine engine 100 may include a gearbox mechanically between low-pressure turbine 118 and fan 113.

One or more components of turbine engine 100 may be considered to form a core section. For instance, one or more of high-pressure compressor 114, diffuser 115, combustor 116, and high-pressure turbine 117 may form the core section of turbine engine 100. The core section may may be surrounding by casing 141. Casing 141 may surround core the core section and bifurcate inlet airflow A into bypass airflow B and core airflow C. Casing 141 may include one or more layers configured to serve different purposes. For example, casing 141 may include a liner layer configured to stop a broken blade from a compressor or turbine from projecting through casing 141 and damaging portions of turbine engine.

Casing 141 may include one or more components. For example, casing 141 may include splitter casing 143 at a fore portion of turbine engine 100, core casing 145 surrounding a core section of the engine, and/or tail casing 120 at an after portion of the engine. The different portions may be selectively tailored to meet temperature and mechanical requirements at different axial positions of the engine. In some examples, casing 141 may be surrounded by fairing 147. Fairing 147 may be configured to protect accessory components attached to casing 141 and may provide a smooth, aerodynamic surface for bypass airflow to flow through bypass duct 122, thus reducing drag.

As mentioned above, casing 141 may surround core airflow C and bifurcate inlet airflow A into bypass airflow B and core airflow C. Casing 141 may include one or more layers configured to serve different purposes. For example, casing 141 may include a liner layer configured to stop a broken blade from a compressor or turbine from projecting through casing 141 and damaging portions of turbine engine.

In some examples, casing 141 may include splitter casing 143, core casing 145, and tail casing 120. Splitter casing 143 may be formed fore of high-pressure compressor 114 and aft of fan 113, and may bifurcate inlet airflow A into core airflow C and bypass airflow B. Core casing 145 may surround core section 146. In some examples, splitter casing 143 may be directly connected to core casing 145. Alternatively, one or more intervening components may be included. For example, an intermediate casing may be positioned between splitter casing 143 and core casing 145. Tail casing 120 may be directly connected to core casing 145 at a downstream end of core casing 145, and may guide core airflow C as core airflow C is outlet from turbine engine 100. In accordance with one or more examples of the present disclosure, turbine engine 100 includes electrical generator 132, which may be positioned aft of at least one turbine. For example, electrical generator 132 may be positioned aft of low-pressure turbine 118. As disclosed herein, “fore” refers to those positions axially upstream along longitudinal axis 111 relative to inlet airflow A entering turbine engine 100, while “aft” refers to those positions axially downstream along longitudinal axis 111.

Electrical generator 132 may be any type of electrical generator and may generally include rotor 152 and stator 150 that rotate relative to each other. Rotor 152 may be mechanically rotated by a plurality of blades of stage 175. In some examples, stage 175 may be a free stage configured to rotate independently of other components of turbine engine 100. Stage 175 may be positioned downstream of a lowest-pressure turbine (low-pressure turbine 118 in the illustrated example). In such examples, stage 175 may extract work from core airflow C, because high-pressure turbine 117 and low-pressure turbine 118 may not completely expand core airflow C. In this way, electrical generator 132 may generate electrical power using available and unused work for turbine engine 100.

In some examples, stage 175 may carry rotor 152 of electrical generator 132 on an outer diameter of the plurality of blades of stage 175. The outer diameter may, in some examples, be the tip of the blades, but is not so limited. For example, the outer diameter may mean that the radial center of rotor 152 is on the radially outer half of blades of stage 175. Furthermore, as primarily described herein, electrical generator 132 is integrated into stage 175, which is positioned aft of low-pressure turbine 119. However, in some examples, electrical generator 132 may be integrated into another location in turbine section 146, such as by positioning stage 175 between high-pressure turbine 117 and low-pressure turbine 118. Arranging rotor 152 on the outer diameter of the plurality of blades of stage 175 may enable inclusion of a relatively larger and/or more powerful electrical generator 132 when compared to other locations of rotor 152. In some examples, stator 150 may be positioned radially outward of rotor 152. Arranged as such, electrical generator 132 may enable inclusion of a relatively larger and/or more powerful electrical generator 132 when compared to other locations of stator 150.

Rotation of the plurality of blades of stage 175 during operation of turbine engine 100 may cause rotation of rotor 152, which may be attached to or integral with the plurality of blades of stage 175. Electrical generator 132 further includes stator 150. In some examples, at least a portion of stator 150 may be integrated into casing 141, such as in tail casing 120 at the same axial position as rotor 152. Stator 150 may thus be stationary relative to turbine engine 100. The relative rotation of rotor 152 to stator 150 may enable electrical generator 132 to generate electrical energy.

Electrical generator 132 may be any type of electrical generator. Examples of electrical generator 132 include, but are not limited to, alternators, dynamos, permanent magnet generators, field wound generators, synchronous, asynchronous, brushed, brushless, etc. Rotor 152 and stator 150 of electrical generator 132 may be concentric with a drive shaft of high-pressure compressor 114, which may also be concentric with fan 113 (e.g., shaft connecting turbine 119 to fan 113). In other words, electrical generator 132 may be positioned such that it is centered on longitudinal axis 111.

Positioning electrical generator 132 aft of at least one turbine (e.g., high-pressure turbine 117 and/or low-pressure turbine 118) may provide various advantages (e.g., over upstream or external positions). For instance, there may be a relatively large volume available, which may enable use of a larger generator (e.g., for a larger total power output and/or a wider range of power extraction options). Inclusion of electrical generator 132 in a location aft of low-pressure turbine 118 may enable turbine engine 100 to include relatively larger and/or relatively more efficient electrical generators. Furthermore, positioning electrical generator downstream of low-pressure turbine 118 may position electrical generator 132 in the lowest temperature region of turbine section 146, which may improve the performance of electrical generator 132

Although locating electrical generator 132 in a location aft of low-pressure turbine may provide improved performance of electrical generator 132 relative to upstream or external locations due to the relatively large volume available, as discussed above, there may be challenges with locating an electrical generator in the hot section of the turbine engine (e.g., downstream of combustion equipment 116). For example, temperatures in such a space may be relatively high, which may reduce performance of electrical generator 132 (e.g., as performance of electrical generators may degrade when heated). Downstream of combustion equipment 116 (e.g., in or aft of turbine section 146), combustion products in core airflow C may cause temperatures that are higher than a temperature threshold that electrical generator 132 may be safely operated. For example, magnets in rotor 152 of electrical generator 132 may be exhibit reduced performance above the temperature threshold.

One or more aspects of the present disclosure relate to techniques for maintaining the operating temperature of electrical generator 132 below the temperature threshold. In some examples, the disclosed thermal management systems, which involve cooling electrical generator 132 with bypass air from bypass airflow B, may reduce or eliminate the need for a thermal management that includes one or more of a liquid cooling fluid (e.g., engine oil), heat exchangers, a flooded stator, or the like.

For example, electrical generator 132 may include stator 150 that is at least partially integrated into casing 141 or positioned radially outside of casing 141. Thus, stator 150 may be configured to be cooled by bypass airflow B rather than core airflow C. Accordingly, heat generated by electrical generator 132 may be removed from stator 150, which may increase the performance of electrical generator 132 by reducing the operating temperature of stator 150.

In accordance with some examples, aspects of the present disclosure relate to cooling electrical generator 132 with bypass air from bypass airflow B. Since bypass air may be relatively cooler than air in core airflow C in turbine section 146, cooling with bypass air may reduce the operating temperature of electrical generator 132 and consequently improve performance of electrical generator 132. For example, one or more portions of electrical generator 132 (e.g., stator 150) may be at least partially integrated into casing 141 such that stator 150 is cooled by bypass airflow B. For example, stator 150 may include a stator frame and stator windings, and one or both of the stator frame and stator windings may be integrated into casing 141 and cooled by air from bypass airflow B. Exposure to the relatively cool air of bypass airflow B may decrease an operating temperature of electrical generator 132, which may improve the efficiency of electrical generator 132. In this way, the present disclosure may enable increased energy generation of electrical generator 132.

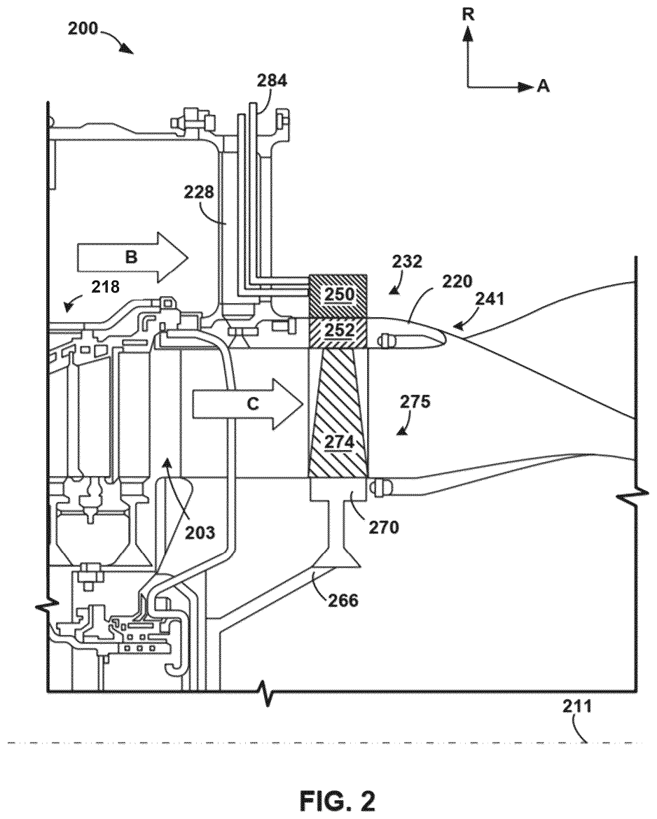

FIG. 2 is a conceptual diagram illustrating further details of example turbine engine 200 with electrical generator 232 positioned aft of at low-pressure turbine 218, in accordance with one or more examples of the present disclosure. Turbine engine 200 of FIG. 2 may generally be described similarly to turbine engine 100 of FIG. 1, differing as described below.

Turbine engine 200 operates to compress and combust core airflow C before expanding core airflow C across one or more turbines, as described above. The turbine section includes low-pressure turbine 218 which includes low-pressure turbine stage 203, which may be the last and lowest-pressure turbine stage of turbine engine 200. Turbine engine 200 includes electrical generator 232 positioned aft of low-pressure turbine stage 203.

Electrical generator 232 includes rotor 252 and stator 250. Rotor 252 is configured to rotate relative to stator 250 to generate electrical power. In some examples, as illustrated, rotor 252 is carried on an outer diameter (e.g., a tip) of blade 274 of stage 275. Blade 274 of stage 275 may a one of a plurality of blades of stage 275. Rotor 252 may be a separate element joined to blade 274, or may be formed integrally with blade 274.

Stage 275 may be positioned aft of low-pressure turbine 218. In some examples, stage 275 may be positioned axially within core exhaust nozzle (155, FIG. 1). Stage 275 may be positioned aft of all turbine stages of turbine engine 200. The plurality of blades of stage 275, including blade 274, may be positioned in core airflow C. Stage 275 may be configured to be rotated by core airflow C. The rotation of stage 275 may mechanically drive rotor 252, which is carried on an outer diameter of blade 274. In some examples, stage 275 may be mounted on bearing 270. Bearing 270 may be supported by one or more mechanical linkages 266. Bearing 270 may be configured to rotate independently of other components of engine 200. As such, stage 275 may be a free stage, only sharing longitudinal axis 211 with other components of turbine engine 200.

As mentioned above, the temperature of core airflow C aft of low-pressure turbine 219 may be high due to the presence of combustion products in core airflow C. Although there may be space available for stage 275 and blade 274 in the downstream location, the high temperature in this region (e.g., the hot section) of turbine engine 200 may present challenges to the incorporation of an electrical generator. In some examples, at least a portion of electrical generator 232 may be cooled by bypass airflow B, which is cooler than the core airflow in the hot section of the engine. In this way, the present disclosure may enable inclusion of electrical generator 232 in such a location without breaking down or performing poorly due to high temperature. For example, at least a portion of stator 250 may be integrated into casing 241 (e.g., tail casing 220), which separates core airflow C from bypass airflow B. In this, way electrical generator 232 may be operated with reduced or eliminated deleterious effects from the high temperature of the core airflow. Furthermore, such an arrangement may enable work from core airflow C to be extracted to rotate rotor 252 relative to stator 250. In some examples, bypass airflow B way flow over stator 250, cooling stator 250 with the relatively cooler air of bypass airflow B, transferring thermal energy from stator 250 into bypass airflow B.

The rotation of rotor 252 relative to stator 250 may generate electrical energy. The electrical energy produced by electrical generator 232 may be transported by one or more conductors 284 from electrical generator 232. For example, one or more conductors 284 may be routed through strut 228 to other parts of turbine engine 200.

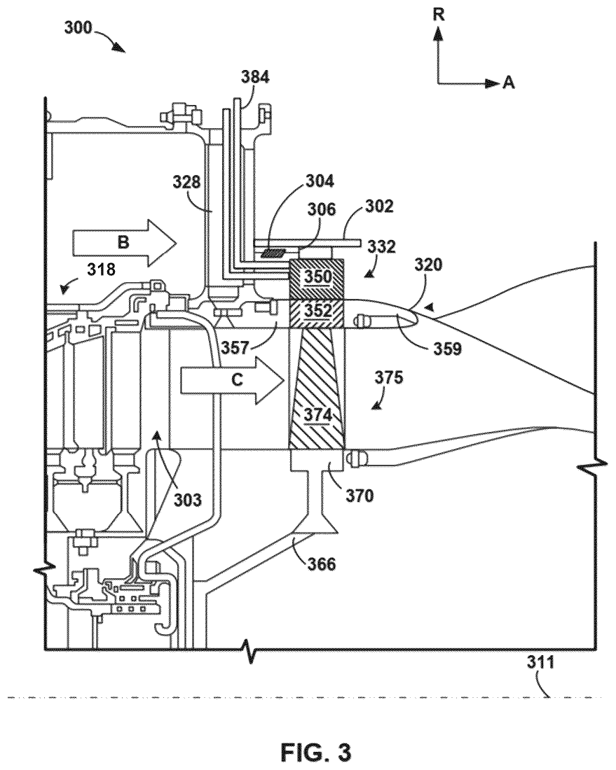

FIG. 3 is a conceptual diagram illustrating further details of an example turbine engine 300. Turbine engine 300 of FIG. 3 may be generally described similarly to turbine engine 200 of FIG. 2, differing as described below. In some examples, tail casing 320 may be separated into first portion 357 and second portion 359. An axial gap along axial axis A may separate first portion 357 from second portion 359, allowing space for integration of electrical generator 332. For example, rotor 352 may rotate in the axial gap between first portion 357 and second portion 359.

Stator 350 may be adjustable in one or more of an axial or radial position. Inclusion of an adjustable stator may be advantageous to account for potential deflection of rotor 352 (e.g., due to rotational speed, thermal expansion, or other causes). In some examples. Stator 350 may be mounted on rail 302. One or more springs 304 may maintain the relative positional relationship between rotor 352 and stator 350. Other position-adjustable elements may be included, such as one or more radial support arms 306. Radial support arms 306 may be adjustable (e.g., by set screws or the like).

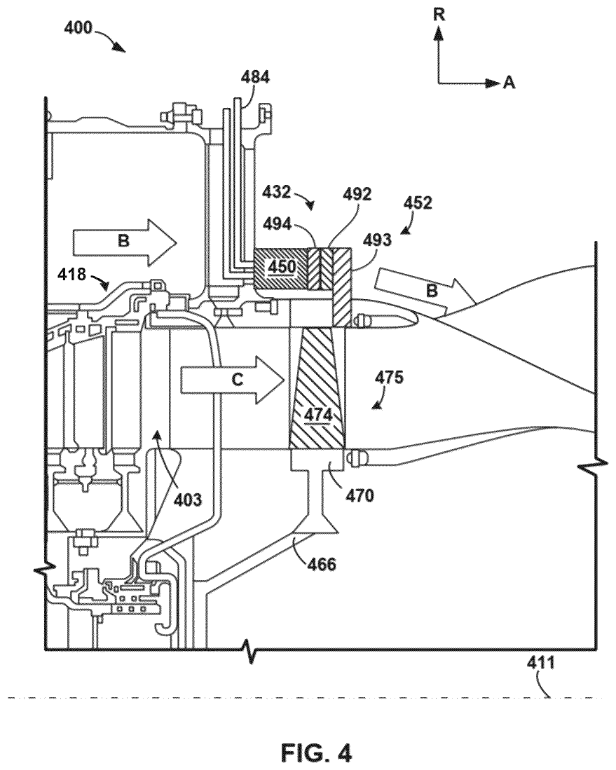

FIG. 4 is a conceptual diagram illustrating further details of example turbine engine 400. Turbine engine 400 may be generally described similarly to turbine engine 100 of FIG. 2, turbine engine 200 of FIG. 2, and turbine engine 300 of FIG. 3, except where differing as described below. Similar reference numerals indicate similar elements.

In some examples, both rotor 452 and stator 450 of electrical generator 432 may be configured to be cooled by bypass airflow B. For example, both stator 450 and rotor 452 may be configured to protrude into bypass airflow B. In some examples, stator 450 and rotor 452 may be displaced from longitudinal axis 411 by the same or a similar radial distance, and instead be displaced from each other axially. Such an arrangement may advantageously increase cooling flow to rotor 452, which may be susceptible to performance degradation due to high temperatures of core airflow C.

In some examples, rotor 452 may include extension member 493, which may extend from blade 474 of stage 475. Rotor 452 may include back iron 492 and one or more magnets 494. In this way, rotor 452 may be mechanically driven by stage 475 to rotate rotor 452 relative to stator 450 to generate electricity.

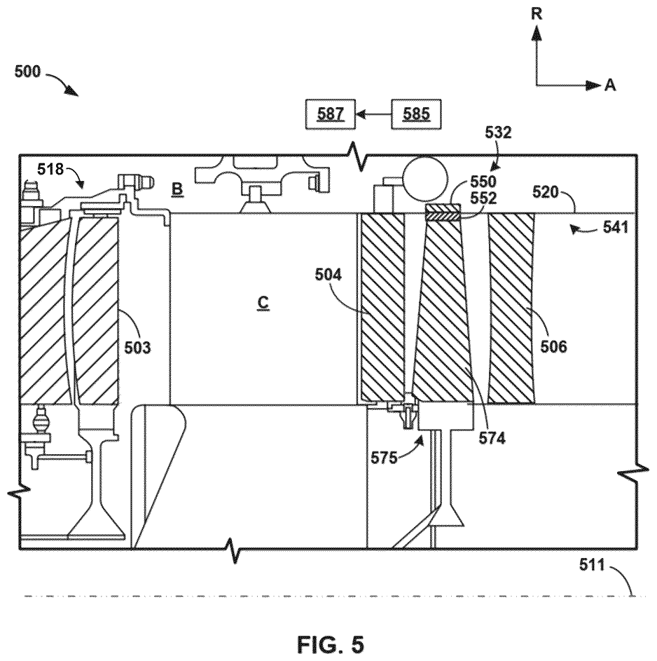

FIG. 5 is a conceptual diagram illustrating further details of example turbine engine 500. Turbine engine 500 may be generally described similarly to turbine engine 100 of FIG. 1, turbine engine 200 of FIG. 2, turbine engine 300 of FIG. 3, or turbine engine 400 of FIG. 4, except where differing as described below. Similar reference numerals indicate similar elements.

Turbine engine 500 includes low-pressure turbine 518, which includes last turbine stage 503. Aft of last turbine stage 503 is positioned electrical generator 532. Electrical generator 532 includes stage 575. Stage 575 includes a plurality of blades, including blade 574, and is configured to rotate in operation of turbine engine 500 via airflow from core airflow C. Rotor 552 may be carried on an outer diameter of the plurality of blades of stage 575. Stator 550 and/or rotor 552 may be at least partially integrated into casing 541 (e.g., tail casing 520) and may be configured to be cooled by bypass airflow B.

In some examples, as illustrated, turbine engine 500 may include one or more inlet guide vanes 504 and/or one or more outlet guide vanes 506. Inlet guide vanes 504 and/or outlet guide vanes 506 may include fixed pitch inlet guide vanes and/or variable pitch outlet guide vanes. Inlet guide vanes 504 may be angled to direct flow at a desired incidence to blade 574 of stage 575. Outlet guide vanes 506 may re-straighten core airflow C as needed (e.g., to control flow into core exhaust nozzle (155, FIG. 1)).

When configured as variable pitch guide vanes, inlet guide vanes 504 may be adjustable to control the way core airflow C interacts with blade 574. In such examples, electrical generator 532 may include actuator that adjust the pitch of variable pitch inlet guide vanes 504. In some examples, electrical generator 532 may include a controller, such as controller 585 which may control actuator 587 to change the pitch of inlet guide vanes 504. In operation, controller 585 may change the pitch of inlet guide vanes 504 in order to adjust an amount of power generated by electrical generator 532.

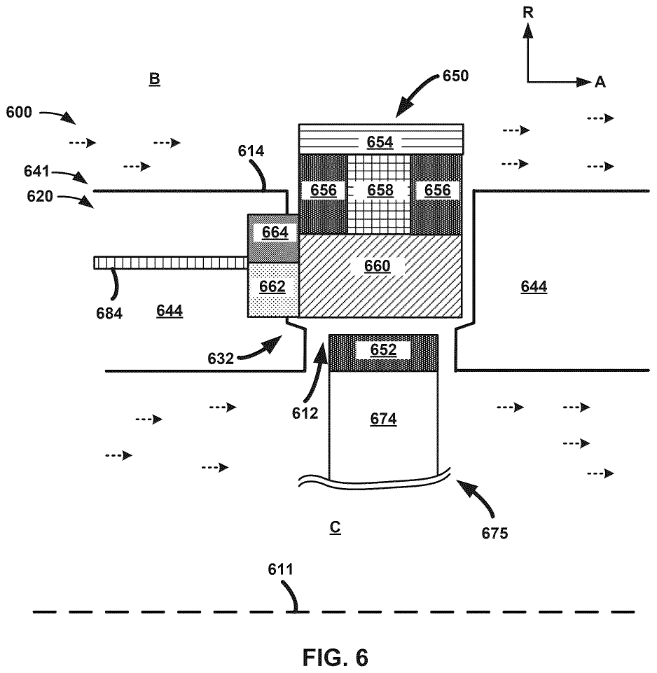

FIG. 6 a conceptual diagram illustrating further details of example turbine engine 600. Turbine engine 600 may be an example of a portion of turbine engine 100 of FIG. 1, except where differing as described below. Similar reference numerals indicate similar elements.

Turbine engine 600 includes electrical generator 632 positioned aft of at least one turbine, in accordance with one or more examples of the present disclosure. Electrical generator 632 includes rotor 652 mechanically rotated by a plurality of blades including blade 674 of stage 675.

Electrical generator 632 further includes stator 650 may include stator frame 654, windings 656, pole 658, and armature 660. Electrical generator 632 may further include commutator 662 and brush 664.

Rotor 652 may rotate about longitudinal axis 611 relative to stator 650. The relative rotation of rotor 652 and stator 650 may generate electrical power. In general, stator frame 654 may mechanically support one or more other components of stator 650, such as windings 656, and pole 658. Electrical generator 632 may also include brush 664. Power generated by electrical generator 632 may be carried through conductors 684, which may be routed through any suitable pathway. As one example, conductors 684 may be disposed in a strut, as described above.

When turbine engine 600 is operating, stage 675 may be configured as a free stage which rotates independent of other components of turbine engine 600. In accordance with one or more aspects of this disclosure, a plurality of blades of stage 675 (only blade 674 is illustrated) may mechanically rotate rotor 652 of electrical generator 632. For example, rotor 652 of electrical generator 632 may be attached to or integral with blade 674, and thus be directly driven by blade 674. For example, rotor 652 may be a hoop rim mounted to the tips and surrounding stage 675, as will be further described below.

In some examples, as illustrated, stator 650 is positioned radially outside of rotor 652. Blade 674 may carry rotor 652 on an outer diameter of blade 674. Put differently, rotor 652 may be positioned radially more distant from longitudinal axis 611 than a majority of blade 674. The outer diameter may, in some examples, be the tip of blade 674, as illustrated. However, in other examples, rotor 652 may not be located at the tip of blade 674, but rather the center of rotor 652 may be positioned on the outer half of blade 674.

In some examples, rotor 652 may be directly attached to blade 674. In some examples, example rotor 652 may be part of blade 674 (e.g., as one or more magnets attached to or formed integrally with compressor blades 674). In some examples, rotor 652 may be a discrete component attached to blades 674. For example, rotor 652 may be a hoop rim. The hoop rim may be an annular ring which includes one or more magnets, and the hoop rim may be attached to the tips of blades 674. In some examples, the hoop rim may completely circumferentially surround stage 675 at a radially outer position (e.g., the tips of blades 674 of stage 675).

As mentioned above, bypass airflow B and core airflow C may be separated by casing 641. For example, casing 641 may include tail casing 620. In the illustrated example of FIG. 6, tail casing 620 may include casing wall 644. Radially outside of casing wall 644 may be bypass airflow B, and radially inside of casing wall 644 may be core airflow C. Although the illustrated example includes a relatively simple tail casing 620 including only casing wall 644, in some examples, tail casing 620 may include more layers, or may include axial segments as different portions of tail casing 620.

Components of electrical generator 632 may be susceptible to high temperature of the hot section of turbine engine 600. Compounding the problems associated with the high temperatures of positions aft of at least one turbine, electrical generator 632 may generate heat during operation. For example, stator windings 656 may generate heat (e.g., due to eddy currents). As electrical generator 232 may operate more efficiently at lower temperatures, it may be desirable to remove heat (i.e., cool) from electrical generator 632. Aspects of this disclosure may enable beneficial cooling of electrical generator 632. For instance, in accordance with the present disclosure, at least a portion of stator 650 may be integrated into tail casing 620 (or other portions of casing 641 of FIG. 1) and cooled by bypass airflow B. The relatively cool air from bypass airflow B may maintain or reduce an operating temperature of electrical generator 632 to below a threshold operating temperature, above which the performance of generator 632 is degraded.

In some examples, stator 650 may be considered integral with tail casing 620 when it forms part of tail casing 620 (e.g., replaces all or a part of an axial section of casing wall 644). In some examples, components of electrical generator 632 may be separated from casing wall 644 of tail casing 620 by gap 612. In some examples, stator 650 may be considered integral with tail casing 620 when a portion of stator 650 is attached casing wall 644 or another component of tail casing 620. As illustrated in FIG. 6, stator 650 may extend radially from casing wall 644 into bypass airflow B. Put differently, stator 650 (e.g., one or more of stator frame 654, windings 656, or pole 658) may protrude into bypass airflow B from tail casing 620 such that stator 650 is exposed to the passing air and consequently cooled, and the thermal energy is rejected into bypass airflow B. In such examples, stator 650 may be protected by a debris shield upstream of stator 650 to protect stator 650 from being damaged by debris (e.g., sand, pebbles, and the like) entering turbine engine 600 with inlet air A.

Bypass air B may thus flow over stator 650 to cool electrical generator 632. Bypass airflow B may conduct heat from operation of electrical generator 632 into bypass airflow B, such as by radiation, convection, and/or conduction. With the cooling provided by bypass airflow B, aspects of this disclosure may enable an electrical generator to be positioned aft of at least one turbine of turbine engine 600, and/or may allow for higher power extraction by electrical generator 632 (e.g., through thermal management). Another benefit that the arrangements of this disclosure may provide is a simpler system without separate or active thermal management (such as oil cooling or refrigerant, etc.). For instance, this disclosure enables cooling without using pumps or moving parts, which may be attractive in certain applications.

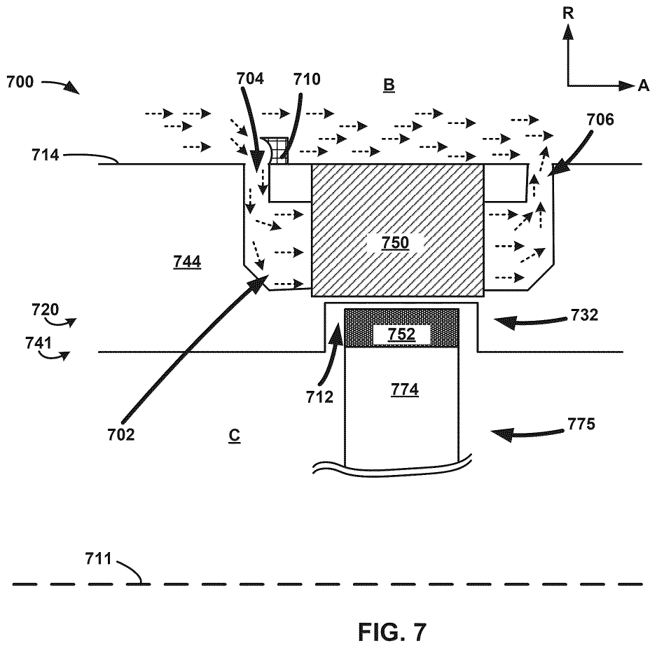

FIG. 7 is a conceptual diagram illustrating further details of one example of turbine engine 700, with electrical generator 732 having rotor 752 which is mechanically rotated by blade 774 of stage 775, in accordance with one or more aspects of this disclosure. Turbine engine 700 may be an example of turbine engine 100 of FIG. 1, where similar reference numerals indicate similar elements.

As illustrated, rather than protruding into bypass airflow B as shown in FIG. 6, in some examples electrical generators of the present disclosure need not protrude into bypass airflow B. For example, electrical generator 732 is integrated into casing wall 744 of tail casing 720, and bypass air from bypass airflow B may be routed to stator 750.

Electrical generator 732 includes stator 750 and rotor 752. Stator 750 and rotor 752 are configured to rotate relative to each other to generate electrical power. In the illustrated example of FIG. 7, stator 750 is completely integrated into casing wall 744. Casing wall 744 and stator 750 (e.g., stator frame and/or stator windings) have a profiled surface to match casing wall 744, such that gas-washed surface 714 of casing 741 includes a portion of both casing wall 744 and stator 750. Put differently, gas-washed surface 714 is smooth and matches across casing wall 744 and stator 750. To increase the cooling of bypass air (illustrated by the short dashed arrows), tail casing 720 may include bypass air bleed duct 702.

Bypass air bleed duct 702 may be configured to fluidically couple the stator windings of stator 750, which generate heat during operation of electrical generator 732, with the relatively cool air of bypass airflow B. As such, bypass air bleed duct 702 may include an inlet 704. Air scoop 710 may optionally be included on gas washed surface 714 to urge bypass air into bypass air bleed duct 702. After flowing over hot portions of stator 750 (e.g., stator windings), bypass air in bypass air bleed duct 702 may be outlet to bypass airflow B through outlet 706. Additionally, or alternatively, bypass air in bypass air bleed duct 702 may be outlet to core airflow C.

In the illustrated example of FIG. 7, rotor 752 is attached or formed at the tip of blade 774. In some examples, rotor 752 may be configured to rotate within recess 712 formed in casing wall 744, which may increase efficiency of electrical generator 732 and/or turbine engine 700 by increasing electrical communication of rotor 752 to stator 750 by decreasing the distance between the components and eliminating or removing intervening materials.

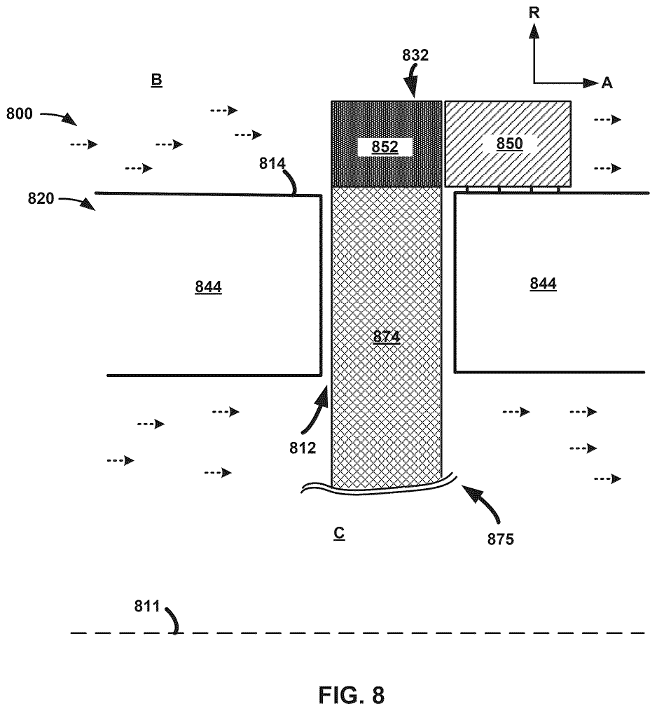

FIG. 8 is a conceptual cross-sectional diagram illustrating another example of a turbine engine. Turbine engine 800 includes electrical generator 832 positioned aft of at least one turbine, in accordance with one or more examples of the present disclosure. Electrical generator 832 includes rotor 852, which is mechanically rotated by blade 874 of stage 875. Turbine engine 500 may be an example of turbine engine 100 of FIG. 1. Turbine engine 800 may generally be described similarly to turbine engine 800 of FIG. 1, except where differing as described below. Similar reference numerals indicate similar elements.

In some examples, as illustrated, rotor 852 and stator 850 of electrical generator 832 may be separated axially rather than radially. In such examples, stator 850 may be positioned axially adjacent to rotor 852. In such examples, rotor 852 may be positioned at a tip (e.g., radially outermost portion) of blade 874. In such examples, rotor 852 may extend through casing wall 844 such that rotor 852 may be cooled by bypass airflow B, which may advantageously reject thermal energy from rotor 852 into bypass airflow B. In some examples, stator 850 may be positioned radially outside of tail casing 820. In some examples, as illustrated, stator 850 may be offset from casing wall 844. Such an arrangement may improve the performance of stator 850 and thus electrical generator 832 by separating stator 850 from the hot surface of casing wall 844. Electrical generator 832 may be integrated into tail casing 820 such that gap 812 may accommodate expansion and contraction of components during at least some operating modes of turbine engine 800 and electrical generator 832.

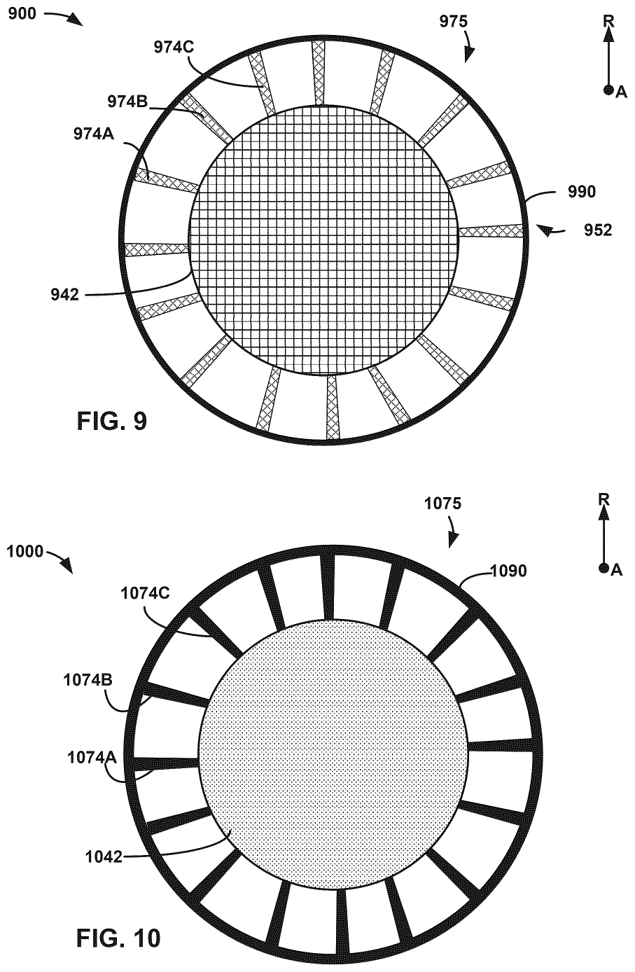

FIG. 9 is a conceptual diagram illustrating a portion of an example turbine engine 900. Turbine engine 900 is illustrated in a front view, such that longitudinal axis (111, FIG. 1) runs into and out of the page. Turbine engine 900 of FIG. 9 may be an example of turbine engine 100 of FIG. 1, and may be generally described similarly, except where differing as described below. Similar reference numerals indicate similar elements.

Turbine engine 900 includes stage 975. Stage 975 includes blades 974A, 974B, 975C (collectively “plurality of blades 974”). Plurality of blades 974 are distributed about the central longitudinal axis of turbine engine 900, projecting outward from inner hub 942. Plurality of blades 974 may mechanically support rotor 952 at a radially outward position (e.g., the tips of plurality of blades 974). In some examples, rotor 952 is configured as a hoop rim 990. Hoop rim 990 is an annular structure completely circumferentially surrounding stage 975 at the radially distal end of plurality of blades 974. Hoop rim 990 includes one or more magnets. The one or magnets of hoop rim 990 are configured to electromagnetically interact with the stator (150, FIG. 1) of the electrical generator (132, FIG. 1). In this way, hoop rim 990 is configured as the rotor (152, FIG. 1).

In some examples, hoop rim 990 may be attached to stage 975 as a separate, discrete component (illustrated by the different cross-hatching of plurality of blades 974 and hoop rim 990). For example, hoop rim 990 may be slid axially over stage 975 and welded or brazed to join the components.

FIG. 10 is a conceptual diagram illustrating a portion of an example turbine engine 1000. Turbine engine 1000 is illustrated in a front view, such that longitudinal axis (111, FIG. 1) runs into and out of the page. Turbine 1000 of FIG. 10 may be an example of turbine engine 900 of FIG. 9, and may be generally described similarly, except where differing as described below. Similar reference numerals indicate similar elements.

Unlike plurality of blades 974 and hoop rim 990 of FIG. 9, which are separate components, turbine 1000 of FIG. 10 illustrates plurality of blades 1074 and hoop rim 1090 formed integrally in one piece (illustrated as uniform in color). As such, in some examples, hoop rim 1090 and plurality of compressor blades 1074 may be machined from a single piece of metal or alloy.

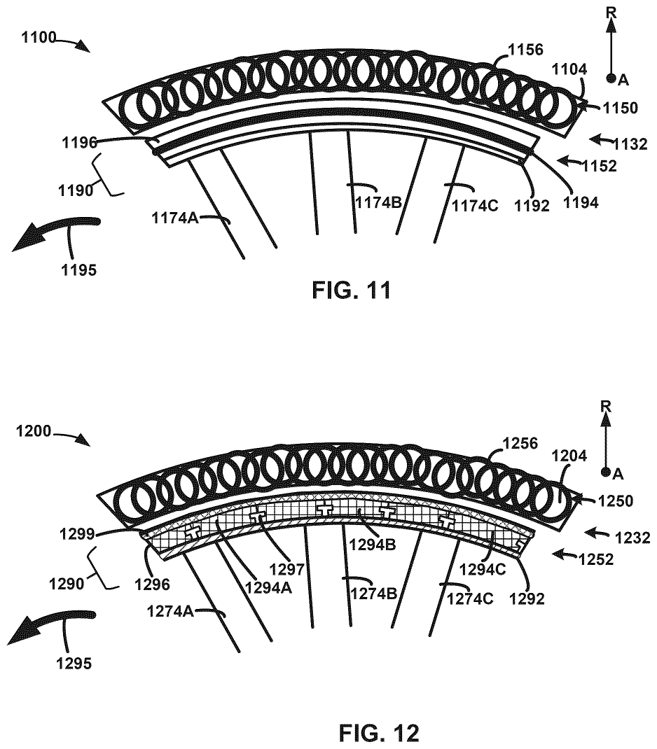

FIG. 11 is a conceptual diagram illustrating a portion of an example turbine engine 1100. Turbine engine 1100 is illustrated in a front view, such that longitudinal axis (111, FIG. 1) runs into and out of the page. Turbine engine 1100 may be an example of turbine engine 100 of FIG. 1, and may be generally described similarly, except where differing as described below. Similar reference numerals indicate similar elements.

Turbine engine 1100 includes electrical generator 1132. Electrical generator 1132 includes stator 1150 and rotor 1152. Rotor 1152 is configured to rotate about the longitudinal axis in the direction of arrow 1195 while stator 1150 remains motionless relative to turbine engine 1100, Stator 1150 may be at least partially integrated into tail casing (120, FIG. 1). The relative rotation of rotor 1152 to stator 1150 may produce electricity. Stator 1150 includes stator windings 1156 wound about the stator frame. Stator windings 1156 may be encased or mechanically supported by glass composite sleeve 1104.

Rotor 152 is a hoop-rim rotor. As such, hoop rim 1190 is mounted to the tips of blades 1174A, 1174B, 1174C (collectively “blades 1174”) of a stage (e.g., stage 175 (FIG. 1)) and completely surrounds longitudinal axis 111 (FIG. 1). Hoop rim 1190 may be configured to fit into a gap (612, FIG. 6) of a casing wall (644, FIG. 6) of a casing (141, FIG. 3). Hoop rim 1190 includes one or more magnets 1194, composite structure 1196, and back iron 1192. Hoop rim 1190 may completely circumferentially surround the stage. Arranged as such, electrical generator 1132 and be mechanically rotated by stage 175 while blades 1174 extract work from the core airflow (C, FIG. 1) to rotate rotor 1152.

As illustrated, one or more magnets 1194 may be a single, continuous magnet which completely surrounds the longitudinal axis (111, FIG. 1). Where manufacturing or assembly challenges make a continuous magnet difficult, one or more magnets 1194 may include a plurality of magnets adjacent to each other around hoop rim 1190. Such an arrangement may improve balance and/or performance of electrical generator 1132. One or more magnets 1194 may include any suitable magnetic material. For example, advanced magnetic materials including samarium cobalt and/or neodymium iron boron may be included in one or more magnets 1194.

Composite structure 1196 is configured to provide mechanical strength and stiffness to hoop rim 1190 and mechanically support one or more magnets 1194. In some examples, composite structure 1196 may include a carbon fiber wrap. The carbon fiber wrap may include woven carbon fibers or unidirectional carbon fibers surrounding one or more magnets 1194. Composite structure 1196 may secure one or more magnets 1194 in place, while providing lightweight and temperature resistant structure to hoop rim 1190.

Back iron 1192 is configured to increase the magnetic flux and torque of electrical generator 1132. In some examples, back iron 1192 may form the return path of flux between one or more magnets 1194 and other components of rotor 1152. In some examples, back iron 1192 may include iron-silicon, a specialty alloy such as iron-cobalt vanadium, another high magnetic saturation alloy, or other materials. Blades 1174 and portions of hoop rim 1190 may be formed from titanium or another suitable material. Hoop rim 1190 may be machined as a single piece or may be assembled from multiple different pieces.

With electrical generator 1132 integrated into turbine engine 1100 in this way, reliable electrical communication may be enabled between rotor 1152 and stator 1150. Furthermore, the illustrated arrangement may allow for stator 1150 to be cooled by bypass airflow (B, FIG. 1). Thus, turbine engine 1100 may provide improved electricity production, improved electrical efficiency, reduced additional weight and space, or other benefits.

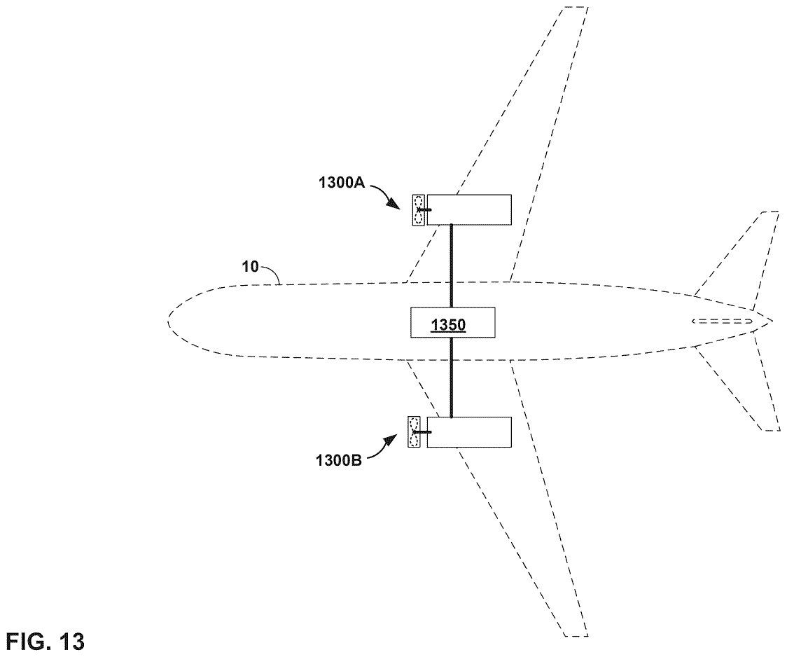

FIG. 12 is a conceptual diagram illustrating a portion of an example turbine engine 1200. Turbine engine 1200 may generally be described similarly to turbine engine 1100 of FIG. 1 except where differing as described below. Similar reference numerals indicate similar elements.

Turbine engine 1200 includes electrical generator 1232. Electrical generator 1232 includes stator 1250 and rotor 1252. Rotor 1252 is configured to rotate about the longitudinal axis in the direction of arrow 1295 while stator 1250 remains motionless relative to turbine engine 1200 to produce electricity. Stator 1250 includes stator windings 1256 wound about the stator frame. Stator windings 1256 may be encased in glass composite sleeve 1204, either individually as a whole. Stator 1250 is configured to be integrated into the tail casing (120, FIG. 1) of turbine engine 1200.

Rotor 1252 is a hoop-rim rotor 1290, as described above. Hoop rim 1290 includes one or more magnets 1294, composite structure 1296, and back iron 1292. Composite structure 1296 includes carbon fiber wrap 1299.

As illustrated, one or more magnets 1294 may include a discrete plurality of magnets 1294A, 1294B, 1294C. In some examples, each magnet of the one or more magnets 1294 should be displaced from every other magnet of one or more magnets 1294 by the same amount of space, which may be important for balance during operation. in some examples, the number of magnets of one or more magnets 1294 may be proportional to the number of blades in blades 1274. For example, each blade may have a corresponding magnet, or each blade may correspond to multiple magnets, or a magnet may be positioned every other blade, or the like. Selectively tailoring the number of magnets in one or more magnets 1294 may enable performance and/or manufacturing efficiency.

In some examples, composite structure 1296 may be shaped to secure magnet 1294A within hoop rim 1290. For example, composite structure 1296 may define retention feature 1297. When magnet 1294A is slid into place, retention feature 1297 radially and circumferentially secures magnet 1294A in hoop rim 1290. Retention feature 1297 may include one or more tabs or protrusions which may increase the surface area of contact between one or magnets 1294A and surrounding composite structure 1296, which may more securely hold magnet 1294A in place during operation. In some examples, an adhesive (e.g., a high-temperature two-part epoxy adhesive) may be included to further secure magnet 1294A in position within hoop rim 1290. The adhesive may be referred to as an adhesive layer.

In some examples, one or more magnets 1294 may be permanent magnets. In or more instances, one or more magnets 1294 may be arranged such that they form a Halbach array. Accordingly, one or more magnets 1294 may have a spatial rotating pattern of magnetization such that the magnetic field on the radially external side of one or more magnets 1294 (e.g., facing stator 1250) is relatively large while the magnetic field on the radially inner side (e.g., closer to the central longitudinal axis (111, FIG. 1)) is cancelled such that it is zero or nearly zero.

FIG. 13 is a conceptual diagram illustrating an example aircraft, in accordance with one or more aspects of the disclosure. Aircraft 10 of FIG. 10 may be aircraft that includes one or more turbine engines 1300A and 1300B (collectively, “turbine engines 1300”), which may provide thrust and/or electrical power to aircraft 10. Examples of aircraft 10 include, but are not limited to fixed wing, rotorcraft, vertical takeoff (e.g., VTOL), short takeoff (e.g., STOL), and the like.

Each of turbine engines 1300 may be an example of turbine engine 100 of FIG. 1. As one example, turbine engine 1300A may include an electrical generator having a rotor mechanically rotated by a plurality of blades of a stage positioned aft of at least one turbine.

One or more of turbine engines 1300 may output electrical power to a load of aircraft 10, such as load 1350. In some examples, load 1350 may be a relatively high-power consumption load. As such, it may be desirable to include higher power generation capacity electric machines that can operate with high efficiency without being degraded due to high temperature, such as those described in this disclosure.

The following numbered examples demonstrate one or more aspects of the disclosure.

Example 1: A turbine engine includes at least one compressor; combustion equipment; at least one turbine; a stage positioned aft of the at least one turbine includes a rotor carried on an outer diameter of the plurality of blades of the stage and mechanically rotated by the plurality of blades of the stage, the rotor configured to rotate about a longitudinal axis of the turbine engine; and a stator.

Example 2: The turbine engine of example 1, wherein the stator is positioned radially outward of the rotor.

Example 3: The turbine engine of any of examples 1 and 2, wherein the at least one turbine comprises a low-pressure turbine, and wherein the stage is positioned aft of the low-pressure turbine.

Example 4: The turbine engine of any of examples 1 through 3, wherein the stage is a free stage configured to rotate independently of other components of the turbine engine.

Example 5: The turbine engine of any of examples 1 through 4, further comprising a variable inlet guide vane positioned fore of the stage, the variable inlet guide vane configured to control an incidence of a core airflow on the stage.

Example 6: The turbine engine of any of examples 1 through 5, further comprising a support bearing configured to mechanically support the plurality of blades of the stage.

Example 7: The turbine engine of any of examples 1 through 6, further comprising a casing, the casing bifurcating an inlet airflow entering the turbine engine into a bypass airflow and a core airflow.

Example 8: The turbine engine of example 7, wherein the casing comprises a splitter casing, a core casing, and a tail casing.

Example 9: The turbine engine of example 8, wherein at least a portion of the stator is at least partially integrated into the tail casing and configured to be cooled by the bypass airflow.

Example 10: The turbine engine of any of examples 8 and 9, wherein the stator includes one or more stator windings mechanically supported by a stator frame, and wherein the one or more stator windings protrude from the tail casing into the bypass airflow to be cooled by the bypass airflow.

Example 11: The turbine engine of any of examples 8 through 10, wherein the stator includes one or more stator windings mechanically supported by a stator frame, wherein the stator frame is profiled to match the tail casing, and the turbine engine further comprising a bypass air bleed duct that routes bypass air from the bypass airflow to the stator windings to cool the stator windings.

Example 12: The turbine engine of example 11, wherein the bypass air bleed duct is outlet into the bypass air flow.

Example 13: The turbine engine of any of examples 1 through 12, wherein the rotor comprises a hoop rim attached to or integral with the stage.

Example 14: The turbine engine of example 13, wherein the hoop rim completely circumferentially surrounds the stage.

Example 15: The turbine engine of any of examples 13 and 14, wherein the hoop rim includes one or more magnets and a composite structure.

Example 16: The turbine engine of example 15, wherein the one or more magnets include a plurality of magnets, wherein the plurality of magnets includes a first magnet, and wherein the first magnet includes a retention feature to radially secure the first magnet in the hoop rim.

Example 17: The turbine engine of example 16, wherein the one or more magnets include a plurality of magnets, and wherein the plurality of magnets define a Halbach array.

Example 18: The turbine engine of any of examples 15 through 17, wherein the hoop rim further comprises a back iron radially inboard of the one or more magnets.

Example 19: An airframe includes a first turbine engine of one or more turbine engines, the first turbine engine includes at least one compressor; combustion equipment; at least one turbine; a stage positioned aft of the at least one turbine includes a rotor carried on an outer diameter of the plurality of blades of the stage and mechanically rotated by the plurality of blades of the stage, the rotor configured to rotate about a longitudinal axis of the turbine engine; and a stator.

Example 20: The airframe of example 19, wherein the stator is positioned radially outward of the rotor.

Various examples have been described. These and other examples are within the scope of the following claims.

What is claimed is:

1. A turbine engine comprising:
at least one compressor;
combustion equipment;
at least one turbine;
a stage positioned aft of the at least one turbine, the stage comprising a plurality of blades; and
an electrical generator, the electrical generator comprising:
a rotor carried on an outer diameter of the plurality of blades of the stage and mechanically rotated by the plurality of blades of the stage, the rotor configured to rotate about a longitudinal axis of the turbine engine; and
a stator.

2. The turbine engine of claim 1, wherein the stator is positioned radially outward of the rotor.

3. The turbine engine of claim 1, wherein the at least one turbine comprises a low-pressure turbine, and wherein the stage is positioned aft of the low-pressure turbine.

4. The turbine engine of claim 1, wherein the stage is a free stage configured to rotate independently of other components of the turbine engine.

5. The turbine engine of claim 1, further comprising a variable inlet guide vane positioned fore of the stage, the variable inlet guide vane configured to control an incidence of a core airflow on the stage.

6. The turbine engine of claim 1, further comprising a support bearing configured to mechanically support the plurality of blades of the stage.

7. The turbine engine of claim 1, further comprising a casing, the casing bifurcating an inlet airflow entering the turbine engine into a bypass airflow and a core airflow.

8. The turbine engine of claim 7, wherein the casing comprises a splitter casing, a core casing, and a tail casing.

9. The turbine engine of claim 8, wherein at least a portion of the stator is at least partially integrated into the tail casing and configured to be cooled by the bypass airflow.

10. The turbine engine of claim 8, wherein the stator includes one or more stator windings mechanically supported by a stator frame, and
wherein the one or more stator windings protrude from the tail casing into the bypass airflow to be cooled by the bypass airflow.

11. The turbine engine of claim 8, wherein the stator includes one or more stator windings mechanically supported by a stator frame, wherein the stator frame is profiled to match the tail casing, and
the turbine engine further comprising a bypass air bleed duct that routes bypass air from the bypass airflow to the stator windings to cool the stator windings.

12. The turbine engine of claim 11, wherein the bypass air bleed duct is outlet into the bypass air flow.

13. The turbine engine of claim 1, wherein the rotor comprises a hoop rim attached to or integral with the stage.

14. The turbine engine of claim 13, wherein the hoop rim completely circumferentially surrounds the stage.

15. The turbine engine of claim 13, wherein the hoop rim includes one or more magnets and a composite structure.

16. The turbine engine of claim 15, wherein the one or more magnets include a plurality of magnets,
wherein the plurality of magnets includes a first magnet, and wherein the first magnet includes a retention feature to radially secure the first magnet in the hoop rim.

17. The turbine engine of claim 16, wherein the one or more magnets include a plurality of magnets, and wherein the plurality of magnets define a Halbach array.

18. The turbine engine of claim 15, wherein the hoop rim further comprises a back iron radially inboard of the one or more magnets.

19. An airframe comprising:
a first turbine engine of one or more turbine engines, the first turbine engine comprising:
at least one compressor;
combustion equipment;
at least one turbine;
a stage positioned aft of the at least one turbine, the stage comprising a plurality of blades; and
an electrical generator, the electrical generator comprising:
a rotor carried on an outer diameter of the plurality of blades of the stage and mechanically rotated by the plurality of blades of the stage, the rotor configured to rotate about a longitudinal axis of the turbine engine; and
a stator.

20. The airframe of claim 19, wherein the stator is positioned radially outward of the rotor.
